(19) United States
(12) Patent Application Publication
(10) Pub. No.: US 2013/0024343 A1
(43) Pub. Date: Jan. 24, 2013

(54) METHOD AND ELECTRONIC PROCESSING SYSTEM FOR ROYALTY ALLOCATION

(71) Applicants: Giustino de Sanctis, Lugano (CH); Massimo Mancin, Collegno (IT)

(72) Inventors: Giustino de Sanctis, Lugano (CH); Massimo Mancin, Collegno (IT)

(73) Assignee: SISVEL US, INC., Alexandria, VA (US)

(21) Appl. No.: 13/551,468

(22) Filed: Jul. 17, 2012

Related U.S. Application Data
(60) Provisional application No. 61/509,852, filed on Jul. 20, 2011.

(51) Int. Cl. G06Q 40/00

(52) U.S. Cl. 705/35

(57) ABSTRACT

A method for calculating royalty allocation to a number of licensors includes iteratively the following steps: determining a first value of a share of royalties for each of the licensors based on predetermined criteria; determining a part of the number of licensors as enforcing licensors, based on the determination whether participating in one or more enforcement actions; assigning to each enforcing licensor a second value of a share of royalties based on the royalties paid by those licensees against which the enforcing licensor has participated in one or more enforcement actions; and determining a percentage of royalty to be allocated to each licensor based on the first value and the second value.

### CROSS-REFERENCE TO RELATED APPLICATIONS

This application claims the benefit of Provisional Application No. 61/509,852, filed Jul. 20, 2011, which is incorporated herein by specific reference.

### BACKGROUND OF THE INVENTION

1. Field of the Invention

The present invention applies to the management of royalties in the field of joint licensing programs, and in particular concerns a method for allocating to the respective owners the royalties paid by licensees of intellectual property rights in the context of a joint licensing program.

In particular the present invention relates to a method and electronic processing system for royalty allocation.

2. Description of the Prior Art

Joint licensing programs, including patent pools, have become increasingly important in many fields of technology, such as electronics and telecommunications. In fact, the introduction of new technologies generally involves the use of a significant number of inventions made and patented by different entities.

Standards in telecommunications represent an exemplary case: in fact, the creation of each new technical specification is made through a vast number of contributions submitted by the entities participating in the formation process of the standard. Such contributions are discussed, tested and filtered by the technical groups, and those approved are incorporated in the final technical specification.

Those contributions frequently include innovative solutions that may have been patented by the submitting entities. As a consequence, future implementers of that specification will need a license from all the holders of applicable patent rights.

With many different entities holding intellectual property rights (from now on simply referred to as patent portfolios or portfolios) on the same technology, joint licensing programs represent an efficient alternative to negotiating the rights needed with each single right holder. One of the advantages is the simplification of the negotiation process between licensors and licensees. Moreover, joint licensing can also facilitate the obtaining of a license at a lower price compared to the alternative.

Joint licensing programs are typically managed by an independent entity (licensing administrator) that carries over the negotiations with the prospective licensees, collects royalties and distributes them to the licensors. However it is not always like that. Sometimes joint licensing programs are managed by one of the licensors and sometimes are managed by entities owned or otherwise controlled by one or more of the licensors. Obviously other variations are also possible.

In any such case, the royalty distribution of a licensing program is typically implemented through a software running on a machine (personal computer, server) or through a dedicated hardware, which is connected to one or more databases. Those databases typically include information for each licensee and licensor, such as data related to royalty payments (amount, dates, invoices, withholding taxes . . . ) and other company-related information.

The royalty distribution is generally carried out based on mathematical rules that take into account a number of different variables whose value is inputted by the user or stored in a memory, or is obtained through connection to external servers or databases, which may be also used for different purposes, for example a databases that includes financial information (invoices, payments . . . ).

A problem that must be dealt with substantially any joint licensing program is how to allocate the income royalty stream resulting from the joint licensing to the participating licensors (from now on licensors). Different models have been implemented, with the goal generally being of allocating royalties based on the value of the patent portfolios held by each of the licensors.

The different models may take into account several factors, such as the size of the portfolio, the scope of the geographical and technical coverage of the patent portfolios, the types of relevant devices, as well known by the experts in the field.

One major factor that is often taken into account is whether a licensor will enforce its patent rights, independently or by assigning the necessary rights to the licensing administrator. This means that the licensor will actively pursue infringers of its patent rights through litigations or other means in compliance with the applicable laws.

Generally, in the absence of such enforcing activities, most infringers would decline to take a license from the joint licensing program so not to be disadvantaged towards their unlicensed competitors. However, when those enforcement activities are effective, the new licensees are often inclined to take a license for the entire patent pool and not only from the enforcing licensors; this is to avoid possible enforcement activities carried out by the other licensors in the future.

Often in situations like this only a subset of licensors are willing to go through the burden of enforcement, while the entire group generally benefits from the enforcement carried out by few. Therefore, it is generally accepted to give a premium (enforcement premium) to those who actively enforce their patents.

The enforcement premium is typically made of a fixed share of the royalties (the amount of which is agreed in advance) which is distributed only to the enforcing licensors, since normally not all the licensors participate in all the enforcement actions.

It should also be noted that while some litigations may be relatively inexpensive and require little effort, others may be more demanding in terms of effort and cost. Generally, if successful, the latter will greatly impact the licensing program, by increasing the royalty revenue as well as by increasing the chances to convince new implementers to take a license.

The challenge is to divide the enforcement premium among the enforcing licensors so that they are fairly rewarded for their activities. A fixed allocation among the enforcing licensors does not reflect the contributions towards the success of the licensing program, since each licensor's share of the premium would not be based on the litigations in which it has participated.

As an alternative, a multiplier could be applied to the values of the enforcing licensors' patent portfolios instead of the fixed share. However, setting in advance the amount of the multiplier would be arbitrary as well.

### SUMMARY OF THE INVENTION

The primary goal of the present invention is a royalty allocation system where each enforcing licensor is rewarded in a manner that follows the contribution produced by the litigations in which it has participated.

The royalty allocation system of the present invention is suitable to be implemented via software in a personal computer or in a server, and is advantageously able to connect to and obtain data from one or more databases, which are typically managed by the administrator of the licensing program. Such databases generally include information for each licensee and licensor, such as data related to royalty payments (amount, dates, invoices, withholding taxes . . . ) and other company-related information.

The system of the present invention takes several parameters as input values (such as the share of each licensor in the absence of enforcement, amount of the enforcement premium, the royalties collected from each licensee . . . ), such parameters are obtained from databases or are inserted by the user through a suitable user interface and then stored in a memory. Starting from these values, the amount of royalties to be allocated to each of the licensors is determined at each royalty distribution time.

The applicant has noted that the amount of royalties paid by a licensee against which a litigation was successfully completed is an objective parameter indicative of the importance of that litigation, and can be used as basis to divide the enforcement premium.

The system of the present invention is based on a dynamic point allocation method where each enforcing licensor receives a number of points based on the royalties paid by the licensees as a consequence of all litigations in which it has participated.

Accordingly, each licensor's share of the enforcement premium should be proportional to 1) the total number of points that it has received and 2) its share of the royalties in the absence of litigations, as agreed by the licensors (i.e. based on the values of the portfolios or other parameters).

In practice, for a given enforcement action that was concluded with the addition of a new licensee, the amount of points assigned to the participating licensors is equal to, proportional to, or connected to the amount of royalties paid by such licensee. In an embodiment of the present invention, these points are then distributed to the relevant licensors in the same proportion as their share of the royalties in the absence of litigations (i.e. based on the values of the portfolios or other parameters). The share of the enforcement premium of a given licensor is then determined by dividing the number of its points by the total number of points assigned to all licensors.

A second goal of the present invention is to dynamically adapt the royalty allocation system based on changes in the market and the result of new litigations.

To reach this goal, the system of the present invention is such that the number of points assigned to the enforcing licensors is regularly updated, for example at each royalty distribution. In fact, the running royalties paid by licensees against which a litigation was concluded successfully are converted into points for the licensors that participated in the relevant litigations.

According to an embodiment of the present invention, it is provided a method for calculating royalty allocation to a number of licensors, the method being implemented in an electronic processing system comprising a processor and stored executable instructions which, when executed by the processor, implement the method, the method comprising iteratively the following steps: determining a first value of a share of royalties for each of said licensors based on predetermined criteria; determining a part of said number of licensors as enforcing licensors, based on the determination whether participating in one or more enforcement actions; assigning to each enforcing licensor a second value of a share of royalties based on the royalties paid by those licensees against which said enforcing licensor has participated in an enforcing action; determining a percentage of royalty to be allocated to each licensor based on said first value and said second value.

According to another embodiment of the present invention, it is provided an electronic processing system for calculating royalty allocation to a number of licensors, the system comprising a processor and stored executable instructions which, when executed by the processor, perform the calculations iteratively, the system comprising: a first data field storing a first value of a share of royalties for each of said licensors based on predetermined criteria; a second data field storing a part of said number of licensors as enforcing licensors, based on the determination whether participating in one or more enforcement actions; a third data field storing of a second value of a share of royalties based on the royalties paid by those licensees against which said enforcing licensor has participated in one or more enforcement actions; said processor assigning to each enforcing licensor from said second data field said second value from said third data field; said processor determining a percentage of royalty to be allocated to each licensor based on said first value from said first data field and said second value from said third data field.

The present invention is implemented as a computer method that may be implemented in turn through a software running on a machine (personal computer, server) or through a dedicated hardware, which automatically determines the royalties to be distributed to the licensors at each predetermined period. Such method assigns to each enforcing licensor a number of points equal to, proportional to, or connected to the amount of royalties paid by licensees as a consequence of all litigations in which it has participated, and determines the each licensor's share of the enforcement premium based on the assigned points. Such a computer implemented method advantageously provides the licensing administrator with the total amount of royalties to be paid to each participating licensor, inclusive of the enforcement premium that is assigned only to the enforcing licensors.

These goals are obtained through the allocation method as described in the attached claims, which have to be considered as an integral part to the present description.

Other goals, characteristics and advantages of the present invention will be clarified in the following description.

### BRIEF DESCRIPTION OF THE DRAWINGS

For a better understanding of the invention, examples of embodiments of the invention are described in the following, which shall be considered only as non-limiting examples, in connection with the attached drawings wherein:

FIG. 1 shows an embodiment of the royalty allocation method based on the present invention.

FIG. 2 shows a flow chart illustrating the basic steps of the present invention.

FIG. 3 shows a computing environment.

### DETAILED DESCRIPTION OF THE PREFERRED EMBODIMENTS

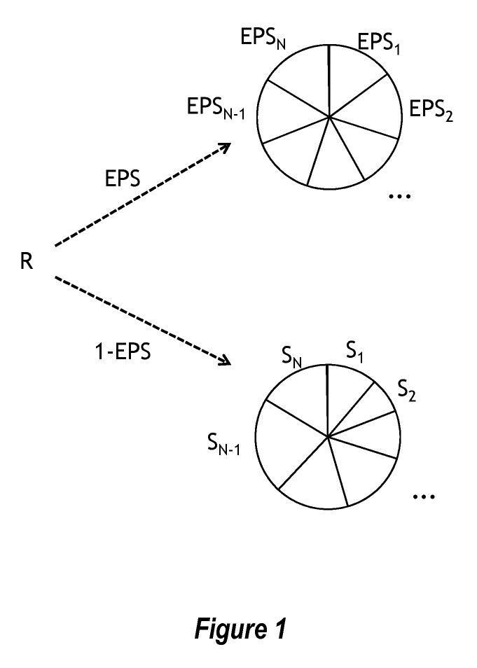

The illustration in FIG. 1 shows an embodiment of the royalty allocation method on which the present invention is based.

In the following we will suppose that a joint licensing program includes N licensors, L₁, L₂ . . . L_{N} (we will use i or j as index) and each of them would have a share of the royalties equal to S₁, S₂, . . . S_{N} respectively in case no enforcement activities are conducted, where Sᵢ is a number between 0 and 1, and the sum S₁+S₂+ . . . +S_{N}=1.

In other words, in the absence of enforcement, the incoming royalties (R) would be divided in the following way: L₁ receives S₁*R, L₂ receives S₂*R . . . L_{N} receives S_{N}*R.

The values S₁ . . . S_{N} may be related to the size of the portfolio of each licensor, the percentage of the relevant market covered by the patent portfolio, the types of equipment that each patent is related to and many other factors. However, S₁ . . . S_{N} may also be the result of the negotiations of the licensors, so including considerations other than the estimated values of their patent portfolios.

The values Sᵢ are stored in a database in connection with the relative licensors, and may be changed by the allowed user every time these shares have to be updated for any reason (e.g when patents expire or new patents are added).

We will also suppose that at a certain time (t₁) joint enforcement activities are started under the coordination of the licensing administrator.

Based on the present invention, all royalties coming from licensees that joined before t₁ will be allocated according to the shares S₁ . . . S_{N} since no enforcing activity has been performed by that time.

FIG. 1 shows how the allocation works after t₁, in case a fixed share (enforcement premium) of the royalties R is allocated to the enforcing licensors. Assuming that EPS (a number between 0 and 1) is the percentage of royalties for the enforcement premium, and the remaining part is 1−EPS, the royalties will be allocated in the following proportions:
EPS*R=enforcement premium, allocated to the enforcing licensors;
(1−EPS)*R=royalties allocated to all licensors according to the shares S₁ . . . S_{N}.

The variable EPS is stored in a memory, and its value may be changed by the allowed user every time this value has to be updated for any reason (e.g if the licensors agree on a different value).

The variable R is the value of the incoming royalties, and may be inputted by the allowed user or may be obtained from a database, directly or by processing a series of values stored in a database (for example as a sum of the royalties paid by the licensees in a certain period of time).

The scheme depicted in FIG. 1 should be applied to the royalties paid by all the licensees that have joined after t1, irrespective of whether they joined as a consequence of a litigation against them or not. In fact, the enforcing activities generally induce infringers to ask for a license so to avoid the risk of possible litigations, therefore the enforcing licensors should be rewarded anyway.

To implement the scheme of FIG. 1 the user needs to insert, for each licensee, the date in which the licensee was added. This may be easily achieved through a user interface, where the addition of a new licensee also requires the insertion of the date of joining.

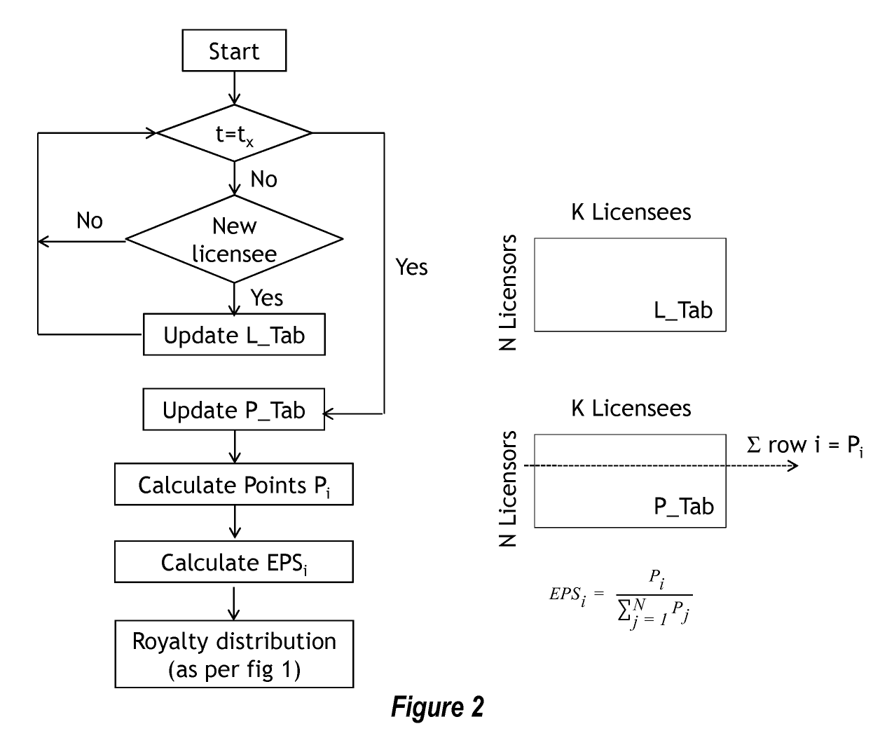

The software implementing the method of the present invention will apply the scheme of FIG. 1 only to the royalties paid by the licensees that joined after t1, while no enforcement premium is applied to the royalties paid by licensees that joined before t1. The illustration in FIG. 2 shows a flow chart of acts or steps associated with methods of the present invention.

The basic idea is that the allocation rules of the enforcement premium should take into account the amount of royalties that each litigation has generated. This goal cannot be accomplished with a fixed allocation, but has to be periodically updated, for example at each royalty distribution (e.g., every quarter, or every six month periods, or according to another periodic interval).

Let's suppose that at a certain time tx (after t1) a number of litigations have been successfully completed and that K licensees have been added to the licensing program after t1, and that each licensor has joined some, all or none of the litigations.

Let's associate to each licensor a Boolean variable bi(m) that indicates whether or not the licensor Li has participated in a litigation against licensee m, so that bi(m)=1 if the licensor Li participated in the relative litigation, and bi(m)=0 if did not. The variables bi(m)=1 can be stored in the database, for example by associating to each licensors Li an array Bi with K boolean elements. The size of the array may change over time since a new element has to be added every time a new licensee is added through an enforcement action.

The table L_Tab (i,m) in FIG. 2 has a row for each licensor and a column for each licensee added through an enforcing action after t1 and before tx (N rows by K columns).

The table L_Tab is a matrix that is stored in a memory and regularly updated every time a new licensee is added through an enforcement action, or every time a new licensor joins the licensing program, or every time the shares Si are changed for any reason.

To calculate the number of points for each licensor, the following calculations are carried out for each element of L_Tab

$$L\_Tab ( i , m ) = \frac{{b}_{i} ( m ) \times {S}_{i}}{{\sum }_{j = 1}^{N} {b}_{j} ( m ) \times {S}_{j}}$$

By applying this formula each element L_Tab (i,m) will include the share of the licensor Li relative to the share of all licensors that participated in the litigation against the mth licensee. Therefore, the sum of each column will be 1.

As an example, let's consider a case with 4 licensors and S1=0.1, S2=0.2 S3=0.3 and S4=0.4. Let's also suppose that licensors 1 and 2 participated in a litigation against licensee q (which means b1(q)=1; b2(q)=1; b3(q)=0; b4(q)=0), while licensors 1 and 3 participated in a litigation against licensee p (which means b1(p)=1; b2(p)=0; b3(p)=1; b4(p)=0).

The qth column of L_Tab will contain the following values:

L_Tab (1;q)=1*0.1/(1*0.1+1*0.2+0*0.3+0*0.4)=0.33

L_Tab (2;q)=0*0.2/(1*0.1+1*0.2+0*0.3+0*0.4)=0.67

L_Tab (3;q)=1*0.3/(1*0.1+1*0.2+0*0.3+0*0.4)=0

L_Tab (4;q)=0*0.1/(1*0.1+1*0.2+0*0.3+0*0.4)=0

The pth column of L_Tab will contain the following values:

L_Tab (1;p)=1*0.1/(1*0.1+0*0.2+1*0.3+0*0.4)=0.25

L_Tab (2;p)=0*0.2/(1*0.1+0*0.2+1*0.3+0*0.4)=0

L_Tab (3;p)=1*0.3/(1*0.1+0*0.2+1*0.3+0*0.4)=0.75

L_Tab (4;p)=0*0.1/(1*0.1+0*0.2+1*0.3+0*0.4)=0

Let's now suppose that the royalty distribution takes place at the time tx and that each of the K licensees pays an amount of royalties RI(m) with m=0, 1 . . . K.

The amount RI(m) may include running royalties paid for each licensed products manufactured or sold, as well as lump sums or royalties for past sales or damages, depending on the agreement among the licensors.

A second table P_Tab (M rows by K columns, the same size as L_Tab) is then built in the following way: before t1 all elements of P_Tab are zeros, and the table is then updated at each royalty distribution by applying the formula:

P_Tab(i,m)<−P_Tab(i,m)+RI(m)*L_Tab(i,m)

The formula above means that the amount RI(m)*L_Tab (i,m) is added to the previous value of the table P_Tab at each royalty distribution.

Therefore, each column of P_Tab includes the cumulative royalties paid by a given licensee that has been added through a litigation, assigned to the licensors that participated in the relevant litigation according to their relative shares.

The table P_Tab is a matrix stored in a memory and regularly updated at every royalty distribution time.

Typically the administrator of the program keeps a database including information related to the payments from the licensees (e.g. date of payment, invoice number, withholding taxes . . . ).

At each distribution the user inserts the reference period (e.g. date of start and end, or specific quarter or semiannual period) and the system retrieves from the database the royalties paid by each licensee in the reference period, so obtaining RI(m).

In the example above, if licensee q pays royalties for 4 Million dollars and licensee p pays 1.5 Million dollars, the columns q and p of P_Tab will be as follows (assuming that it is the first payment from licensee m and p, so the relative columns include all zeros):

P_Tab(1,q)=0.33*4=1.32

P_Tab(2,q)=0.67*4=2.68

P_Tab(3,q)=0*4=0

P_Tab(4,q)=0*4=0

P_Tab(1,p)=0.25*1.5=0.375

P_Tab(2,p)=0*1.5=0

P_Tab(3,p)=0.75*1.5=1.125

P_Tab(4,p)=0*1.5=0

The elements P_Tab (i,m) are to be considered as the points assigned to the licensor Li in connection with the licensee m (for simplicity we consider that 1M dollars corresponds to 1 point). Each licensor Li is then assigned a total number of points equal to the sum of the elements of the respective row of P_Tab.

If Pi is the number of points of Li, then

$${P}_{i} = {\sum }_{m = 1}^{K} P\_Tab ( i , m )$$

Therefore, in the example above (under the assumption that no litigations were completed other than against licensees q and p):

P₁=1.32+0.375=1.695

P₂=2.68+0=2.68

P₃=0+1.125=1.125

P₄=0+0=0

The points so obtained are finally used to calculate the share of the enforcement premium for each licensor (EPSi, a number between 0 and 1), in the following way:

$${ESP}_{i} = \frac{{P}_{i}}{{\sum }_{j = 1}^{N} {P}_{j}}$$

So, in the example above, the total number of points assigned is 5.5, and the shares of the enforcement premium are approximately:

EPS₁=1.695/5.5=0.31

EPS₂=2.68/5.5=0.49

EPS₃=1.125/5.5=0.20

EPS₄=0/5.5=0

Based on the scheme of FIG. 1, if R is the total royalties paid by the licensees added after t1 and that have to be distributed to the licensors, each licensor will receive an amount Ri as follows:

Ri=R×[(1−EPS)×Sᵢ+EPS×EPSᵢ]

It is clear that the tables L_Tab and P_Tab have to be updated with the addition of as many columns as the number of new licensees that have joined after an enforcing action.

An important advantage of the system of the present invention is that, if all licensors participated in all enforcing activities, their share of the royalties would be the same as with no enforcement premium (EPSi=Si).

Obviously the experts in the field could find many variations to the embodiment herein described, still within the scope of the present invention.

For example, the scheme of FIG. 1 may be variable over time so that the amount of the enforcement premium is not fixed for the life of the program, or could be limited in time so that it is zeroed after a certain amount of time. The amount of the enforcement premium is stored in a memory and may be changed by the authorized user or may be changed automatically by the software based on predetermined criteria.

Moreover, it would be possible to include schemes to incentivize enforcement action, such as multipliers added to the points obtained through early litigations or through specific actions against particularly difficult targets, or against small targets.

The scheme in FIG. 1 is illustrative and may be more complicated, including other sub schemes to take into account different factors, for example a portion of the royalties may be divided equally among the licensors, or a portion of the enforcement premium may be divided equally among the enforcing licensors.

The scheme depicted in FIG. 1 does not consider possible expenses or fees deducted before distribution, as well known by the experts in this field, such as the fee for the administrator or the withholding taxes, that however do not affect the implementation of the present invention.

In addition, it is possible to include mechanisms to reimburse costs borne by the administrator or by the licensors, for example by deducting such costs from the royalty income before the regular distribution, or by increasing the fee for the administrator until its costs are covered, or increasing the share of those licensors that bore those costs.

It is likewise clear that the method, the variables and the tables of FIG. 2 do not represent the only possibility to implement the present invention, but the implementers may devise different ways to calculate the shares of the enforcing licensors based on the royalties that each litigation has produced, still within the scope of the present invention.

For example, the points Pi assigned to the licensor Li could be based on the number of patents used in each enforcing activity instead of the share Si. To do so, L_Tab (i,m) shall include the relative number of patents owned by licensor Li and used in the litigation against licensee m. This alternative may be adopted to reward the licensors that make available a large number of patents for enforcement activities. In this case, an array including the number of patents used in each enforcement action has to be stored for each licensor.

In an alternative embodiment of the invention, the table P_Tab is updated at each royalty distribution by applying the formula:

P_Tab(i,m)<−β*P_Tab(i,m)+RI(m)*L_Tab(i,m)

where β is a number higher than 0 and lower than 1. In this way the points obtained through a specific litigation will decrease over time, with a decrease rate that is higher the closer β gets to zero. A similar result is obtained when the table P_Tab is periodically multiplied by β, e.g. once a year or half a year.

In a further alternative embodiment, the enforcement premium may be set as multiplier of the shares S1, S2, . . . SN that were agreed in case no enforcement activities are conducted.

For example, after the enforcement activities are started, each share Si may be multiplied by a quantity Mi that depends on the royalties generated by each litigation in which Li participated, where

Mᵢ=1+H*αᵢ

In the formula above, H is a value agreed by the licensors, and αi is a quantity between 0 and 1 that indicates the relative level of revenues generated by all the enforcement actions in which the licensor Li participated (Mi is so included between 0 and H+1). It is clear that the values Mi have to be updated at each royalty distribution, since αi varies over time.

By applying the enforcement premium, each licensor obtains a share Si′ obtained by applying the following formula:

$${S}_{i}^{′} = \frac{{M}_{i} \times {S}_{i}}{{\sum }_{j = 1}^{N} {M}_{j} \times {S}_{j}}$$

Let's consider again the example above, with 4 licensors (S1=0.1, S2=0.2 S3=0.3 and S4=0.4), where licensors 1 and 2 participated in a litigation against licensee q, licensors 1 and 3 participated in a litigation against licensee p, and where licensee q pays royalties for 4 Million dollars and licensee p pays 1.5 Million dollars.

Let's also suppose that the licensors agreed on a value of H=4 (which means that 1≦Mi≦5).

With the assumptions above:

M₁=1+4*5.5 M$/5.5 M$=5

M₂=1+4*4 M$/5.5 M$=3.9

M₃=1+4*1.5 M$/5.5 M$=2.09

M₄=1+4*0 M$/5.5 M$=1

The multipliers above may then be used to calculate the shares S1′ S2′ S3′ S4′

S1′=(5*0.1)/(5*0.1+3.9*0.2+2.09*0.3+1*0.4)=0.22

S₂′=(3.9*0.2)/(5*0.1+3.9*0.2+2.09*0.3+1*0.4)=0.34

S₃′=(2.09*0.3)/(5*0.1+3.9*0.2+2.09*0.3+1*0.4)=0.27

S₄′=(1*0.4)/(5*0.1+3.9*0.2+2.09*0.3+1*0.4)=0.17

Also in this embodiment it is be possible to include schemes to incentivize enforcement action, for example by applying multipliers to the revenues obtained through early litigations, so that the value αi is higher for the licensors that participated in those early enforcement actions, or by applying different values of H to different licensors (for example, higher for those participating in early litigations).

Moreover, the connection between Mi and αi can be non-linear, for example to incentivize enforcement actions against small targets. In a variation to this latest embodiment, the multiplier Mi is obtained through the formula:

Mᵢ=1+H*(αᵢ)^{f}

Where f is a number higher than 0 and lower than 1.

As suggested above, embodiments of the invention include systems, software and storage devices having stored software for implementing the functionality described throughout this paper. In some embodiments, the invention may comprise or utilize a special purpose or general-purpose computer including computer hardware, such as, for example, one or more hardware processors and system memory, as discussed in greater detail below. Embodiments within the scope of the present invention can also include physical computer-readable media and other computer-readable media for carrying or storing computer-executable instructions and/or data structures. Such computer-readable media can be any available media that can be accessed by a general purpose or special purpose computer system. Computer-readable media that store computer-executable instructions are recordable type storage media or other physical computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM or other optical disk storage, magnetic disk storage or other magnetic storage devices, or any other medium which can be used to record or store desired program code means in the form of computer-executable instructions or data structures and which can be accessed by a general purpose or special purpose computer and which are recorded on one or more recordable type device.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts or steps, it is to be understood that the subject matter defined in the appended claims is not necessarily limited to the described features above. Rather, the described features are disclosed merely for illustrative purposes.

Those skilled in the art will appreciate that the invention may be practiced in network computing environments with many types of computer system configurations, including, personal computers, desktop computers, laptop/notebook computers, message processors, hand-held devices, multi-processor systems, microprocessor-based or programmable consumer electronics, network PCs, minicomputers, mainframe computers, tablets, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

In particular, one or more embodiments of the invention may be practiced with portable consumer computing devices. Portable consumer computing devices or more simply, portable consumer devices, can be any of a broad range of computing devices designed or optimized for portability and for personal use. Portable consumer devices can take a variety of forms, ranging from more traditional notebook and netbook computers to an emerging and rapidly growing market of handheld devices, including smart phones (e.g., the APPLE (PHONE, ANDROID phones, WINDOWS phones, SYMBIAN phones), tablet computers (e.g., the APPLE IPAD, ANDROID tablets), gaming devices (e.g., NINTENDO or PLAYSTATION portable gaming devices, the APPLE IPOD), multimedia devices (e.g., the APPLE IPOD), and combinations thereof. Many of these devices can enable rich user-interactivity by including combinations of output, input, and other sensory devices, such as touch- or pressure-sensitive displays (using capacitive or resistive technologies, for example), still and video cameras, Global Positioning System (GPS) receivers, magnetic compasses, gyroscopes, accelerometers, light sensors, proximity sensors, microphones, speakers, etc. These devices can also comprise a variety of communications devices, such as combinations of cellular modems (e.g., Global System for Mobile Communications (GSM), Code division multiple access (CDMA)), Wireless Fidelity (Wi-Fi) radios, Bluetooth radios, Near Field Communication (NFC) devices, etc. Many portable consumer devices are expandable, such that a user can add new hardware and functionality not present during manufacture of the device. It will be appreciated that as the market for portable consumer devices expands and develops, the functionality of these devices will also expand to utilize new and improved user-interaction devices and communications devices. The embodiments described herein are expansive and can also utilize any future developments in the field of portable consumer devices.

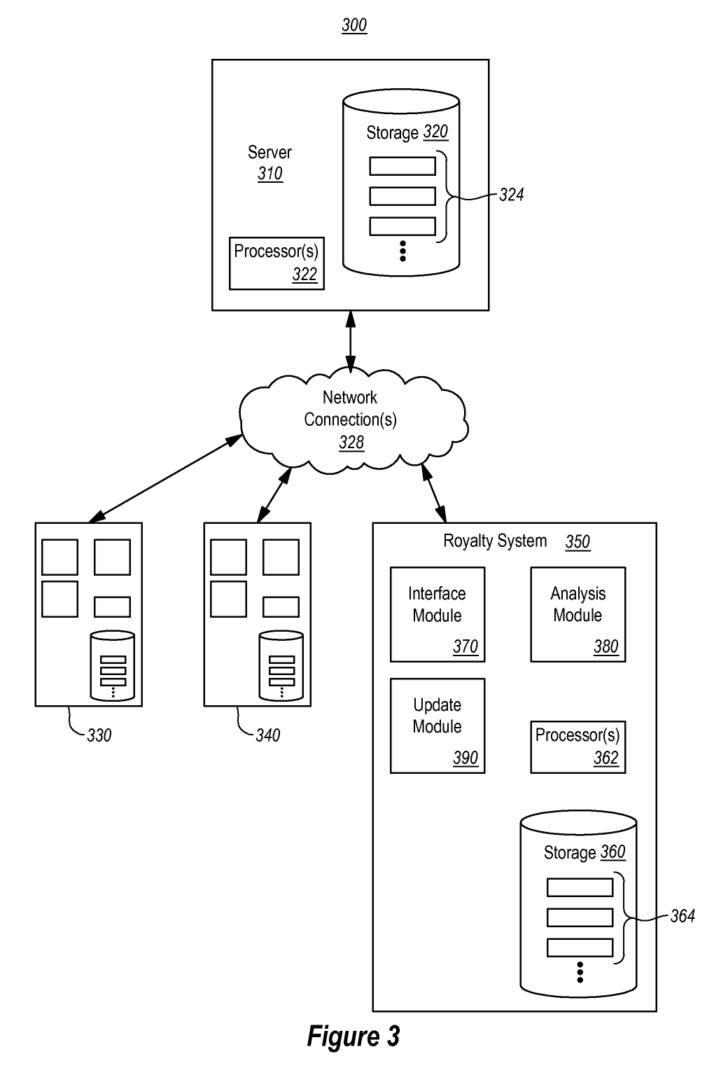

FIG. 3 illustrates one example of a royalty allocation system that is suitable to implement aspects of the claimed invention. As shown, the royalty allocation system 300 includes a server system 310 that includes storage 320 and one or more hardware processors 322 configured to execute computer-executable instructions stored within stored data 324 of the storage 310, as well as computer-executable instructions received from one or more other computing systems.

The storage 320 of the server system 310 comprises system memory and/or one or more other storage media devices which are resident within the server 310 and/or distributed throughout a plurality of other computer devices.

Some of the computer-executable instructions included within the stored data 312 are embodied as input and/or output data structures, such as the royalty matrix tables, royalty calculation data, allocation formulas, criteria and rules, as well as other data elements described throughout this paper, such as, but not limited to license data, patent portfolio data, litigation progress data, and other related data.

Some of the computer-executable instructions are also embodied as modules that enable the server 310 to interface with other computing systems as well as to analyze and update the stored data.

The server 300 receives input directly from a user and/or from another computing system through one or more network connections 328. For example, as shown, the server is in communication with one or more other royalty systems. While the server can also be a stand-alone system, FIG. 3 shows that the server 310 can be connected to three or more other royalty systems, such as systems 330, 340 and 350. Each of these royalty systems 330, 340 and 350 includes comparable storage 360 and processor(s) 362, such as described above in reference to the storage 320 and processor(s) 322 of server 310. For example, the storage 360 can include computer-executable instructions embodied as interface module 370, analysis module 380 and update module 390, which facilitate the interfacing between the computing systems, the analysis of the royalty allocation data, and the updating of the royalty allocation matrices.

According to some embodiments, these other royalty systems comprise specialized clearinghouses or databases that store patent portfolios, litigation dockets, license details, and other specialized data that is automatically accessed and used by the server 310 to update the royalty allocation formulas and matrices stored by the server 310 and that are utilized by the server to thereby calculate the appropriate royalty allocations.

In some embodiments, the updating is performed automatically in response to detecting a change in data stored at one of the royalty systems (330, 340 and 350). The server 310 can detect a change in the data stored that is stored at the royalty system(s) by accessing and analyzing the stored data. This can occur, for example, in response to a query initiated by the server 310 or through a push notification sent periodically by the royalty systems and that is received by the server 310.

The server can detect changes such as, but not limited to a change in the type or quantity of licensee(s) or licensor(s) associated with a patent portfolio, a change in the scope or term of patent portfolio assets, license negotiations, and/or a change in litigation matters associated with the patent portfolio.

In response to a detected change, the server 310 automatically initiates at least one of (1) a change in a formula that is used to calculate the royalty allocation(s), (2) a calculation or recalculation of the royalty allocation(s) using a same or different allocation formula (s), (3) a selection of a timeline or interval for distributing the royalty allocations, (4) a communication to a licensor/licensee regarding the royalty allocation(s) or other related data, (5) generating a revised licensing agreement or updated royalty allocation matrix with new or different data, (6) generation of invoices, (7) distributing the calculated allocation(s) and/or (8) withholding of or payment of taxes. Any combination of the foregoing actions, as well as other actions, can be initiated automatically by the server system in response to the detected changes.

In some embodiments, the server also initiates an action in response to a predetermined criteria specified by a user, such as a periodic interval or in response to a specific corresponding user/administrator request.

What is claimed is:

1. A method for calculating royalty allocation to a number of licensors, the method being implemented in an electronic processing system comprising a processor and stored executable instructions which, when executed by the processor, implement the method, the method comprising iteratively the following steps:
determining a first value of a share of royalties for each of said licensors based on predetermined criteria;
determining a part of said number of licensors as enforcing licensors, based on the determination whether participating in one or more enforcement actions;
assigning to each enforcing licensor a second value of a share of royalties based on the royalties paid by those licensees against which said enforcing licensor has participated in one or more enforcement actions; and
determining a percentage of royalty to be allocated to each licensor based on said first value and said second value.

2. The method of claim 1, wherein said second value is a function of the of the percentage of royalties paid by the licensees against which said enforcing licensor has participated in enforcing actions, compared to the royalties paid by all the licensees against which enforcing actions were taken by any licensor.

3. The method of claim 1 wherein said second value is updated at each royalty distribution to said licensors.

4. The method of claim 1, comprising:
determining the value of an enforcement premium, said enforcement premium being a part of the total of incoming royalties;
determining the apportionment of said enforcement premium to each of said enforcing licensors based on said second value; and
determining the apportionment of the rest of the total of incoming royalties to all licensors based on said first value.

5. The method of claim 4, wherein said enforcement premium is applied to all the royalties paid by all the licensees that have been added after enforcing actions are started by at least one licensor.

6. The method of claim 4, wherein if said enforcing licensors are all of said licensors, the apportionment of said enforcement premium is the same as the apportionment of the rest of the total of incoming royalties.

7. The method as in claim 2, wherein said second value for each enforcing licensor is determined starting from the following expression:
$$L\_Tab ( i , m ) = \frac{{b}_{i} ( m ) \times {S}_{i}}{{\sum }_{j = 1}^{N} {b}_{j} ( m ) \times {S}_{j}}$$
wherein:
L_Tab is in a form of a matrix stored in a memory, with N rows and M columns, M being the number of licensees at a certain time, and wherein a column is added every time a new licensee is added;
each element of L_Tab (i,m) includes the share of the licensor Li relative to the share of all licensors that participated in the litigation against the mth licensee;
N is the number of licensors;
bi(m) is a Boolean variable indicating whether or not the licensor Li has participated in a litigation against licensee m; and
Si, Sj are said first value for each of said licensors, and the sum S₁+S₂+ . . . +S_{N}=1.

8. The method as in claim 7, wherein said second value is determined in compliance with the expression:
P_Tab(i,m)<−P_Tab(i,m)+RI(m)*L_Tab(i,m)
where RI(m) is equal or proportional to the amount of royalty paid by each of said licensees, and where P_Tab is in a form of a matrix stored in a memory, with N rows and M columns, M being the number of licensees at a certain time, and where a column is added every time a new licensee is added.

9. The method as in claim 8, wherein the share of said second value between the enforcing licensors is given by the following expression:
$$\frac{{P}_{i}}{{\sum }_{j = 1}^{N} {P}_{j}}$$
wherein i is the index of the licensor and Pi is defined as follows
$${P}_{i} = {\sum }_{m = 1}^{K} P\_Tab ( i , m )$$

10. The method of claim 1 wherein said second value is a function of the number of patents used by each licensor for each enforcing action.

11. The method of claim 1 wherein said second value is a function of a multiplier β higher than 0 and lower than 1, which is applied to the royalties paid by those licensees against which said enforcing licensor has participated, before said second value is updated as a consequence of a new royalty payment.

12. The method of claim 2 wherein said second value is multiplied by a multiplier, said multiplier being a quantity Mᵢ that is a function of the royalties generated by each litigation in which each licensor has participated, obtaining a new second value.

13. An electronic processing system for calculating royalty allocation to a number of licensors, the system comprising a processor and stored executable instructions which, when executed by the processor, perform the calculations iteratively, the system comprising:
a first data field storing a first value of a share of royalties for each of said licensors based on predetermined criteria;
a second data field storing a part of said number of licensors as enforcing licensors, based on the determination whether participating in one or more enforcement actions;
a third data field storing of a second value of a share of royalties based on the royalties paid by those licensees against which said enforcing licensor has participated in one or more enforcement actions;
said processor assigning to each enforcing licensor from said second data field said second value from said third data field; and
said processor determining a percentage of royalty to be allocated to each licensor based on said first value from said first data field and said second value from said third data field.

14. The system of claim 13, wherein said second value is a function of the of the percentage of royalties paid by the licensees against which said enforcing licensor has participated in enforcing actions, compared to the royalties paid by all the licensees against which enforcing actions were taken by any licensor.

15. The system of claim 13, wherein in said third data field said second value is updated at each royalty distribution to said licensors.

16. The system of claim 13, wherein said processor:
determines the value of an enforcement premium, said enforcement premium being a part of the total of incoming royalties;
determines the apportionment of said enforcement premium to each of said enforcing licensors from said second data field based on said second value from said third data field; and
determines the apportionment of the rest of the total of incoming royalties to all licensors based on said first value from said first data field.

17. The system of claim 16, wherein said enforcement premium is applied only to the royalties paid by the licensees added after enforcing actions are started by at least one licensor.

18. The system of claim 16, wherein if said enforcing licensors are all of said licensors, the apportionment of said enforcement premium is the same as the apportionment of the rest of the total of incoming royalties.

19. The system of claim 14, wherein said processor determines said second value for each enforcing licensor starting from the following expression:
$$L\_Tab ( i , m ) = \frac{{b}_{i} ( m ) \times {S}_{i}}{{\sum }_{j = 1}^{N} {b}_{j} ( m ) \times {S}_{j}}$$
wherein:
L_Tab is in a form of a matrix stored in a memory, with N rows and M columns, M being the number of licensees at a certain time, and wherein a column is added every time a new licensee is added;
N is the number of licensors;
bi(m) is a Boolean variable indicating whether or not the licensor Li has participated in a litigation against licensee m;
Si, Sj are said first value for each of said licensors, and the sum S₁+S₂+ . . . +S_{N}=1.

20. The system as in claim 19, wherein the processor determines said second value to be stored in said third data field in compliance with the following expression:
P_Tab(i,m)=RI(m)*L_Tab(i,m)
where RI(m) is equal or proportional to the amount of royalty paid by each of said licensees, and where P_Tab is in a form of a matrix stored in a memory, with N rows and M columns, M being the number of licensees at a certain time, and where a column is added every time a new licensee is added.

21. The system as in claim 20, wherein the processor determines the share of said second value between the enforcing licensors in compliance with the following expression:
$$\frac{{P}_{i}}{{\sum }_{j = 1}^{N} {P}_{j}}$$
wherein i is the index of the licensor and Pi is defined as follows
$${P}_{i} = {\sum }_{m = 1}^{K} P\_Tab ( i , m )$$

22. The method of claim 13, wherein the processor determines said second value as a function of the number of patents used by each licensor for each enforcing action.

23. The method of claim 13, wherein the processor determines said second value as a function of a multiplier β higher than 0 and lower than 1, which is applied to the royalties paid by those licensees against which said enforcing licensor has participated, before said second value is updated as a consequence of a new royalty payment.

24. The method of claim 14, wherein the processor determines a new second value as a multiplier of said second value, said multiplier being a quantity Mᵢ that is a function of the royalties generated by each litigation in which each licensor has participated.
